(19) United States
(12) Patent Application Publication
(10) Pub. No.: US 2014/0298762 A1
(43) Pub. Date: Oct. 9, 2014

(54) Nano Filter Pump

(71) Applicant: William A Kelley, Austin, TX (US)

(72) Inventor: William A Kelley, Austin, TX (US)

(21) Appl. No.: 13/856,344

(22) Filed: Apr. 3, 2013

(51) Int. Cl. F04B 19/00; F04B 53/20; F04B 19/24; B01D 46/00

(52) U.S. Cl. CPC F04B 19/006; B01D 46/00; F04B 53/20; F04B 19/24; B82Y 99/00
USPC 55/468; 55/529; 417/207; 137/545; 977/742; 977/902

(57) ABSTRACT

A class of devices using nanotubes and nano-shapes which can partially organize molecules in random motion to move either some selectively or all of them, to create pressure differences and hence motive forces, or cause air flow into pressurized area. Because Air is a cloud of particles separated by vacuum, the device in air can be used to create motive force pushing any form of vehicle, lifting force for any form of air vehicle, air compression, power source for any form of machine, conveyor or generator, using the solar energy stored in the air in the form of heat, 24 hours a day, worldwide.

### CROSS-REFERENCE TO RELATED APPLICATIONS

No other patents related.

### STATEMENT REGARDING FEDERALLY SPONSORED RESEARCH AND DEVELOPMENT

This patent is not federally sponsored.

### REFERENCE TO SEQUENCE LISTING, A TABLE, OR A COMPUTER PROGRAM LISTING COMPACT DISC APPENDIX

Not applicable.

### BACKGROUND OF THE INVENTION

Vapor's and gases are largely treated as fluid's. Unlike liquids, the behavior of gases is only fluid-like at large aggregate scales. At scales near the size of air molecules, a vapor, gaseous state or air are all clouds of particles separated by vacuum. Nano scale structures, such as carbon nanotubes are at the right size to create shapes which will interact differently with the cloud of particles than would the same shape at larger scales. Such nano-shape based devices can act as both filters and pumps. While such static shapes apparently are incapable of doing work (true in a sense), the work can be done by the random motion of the particle cloud.

### BRIEF SUMMARY OF THE INVENTION

Disclosed are a class of nano-shapes which, if made on a large scale, such as sheets of material, take the random motion of air or other gaseous state materials to perform as filter's or pumps. Because a pump will change the air pressure on each side of the surface, they will also create a net force in one direction, in the same manner an airplane wing does. The shape will create this air pressure difference without any net velocity (wind direction) within the particle cloud, unlike an airplane wing, which must be in motion. This air pressure difference can provide a motive force, such as a sail, in any direction; create a lifting force, such as a wing, helicopter rotor, or lighter than air balloon. The device can move air in to a higher region of pressure, which can use the heat energy in the air, via the pressure difference, to work as a heat engine powered directly by the heat in the air. An example would be a turbine driven electric generator. The fuel source is the sun, the atmosphere acting as an energy collector, one that holds the energy for use 24 hours a day.

### BRIEF DESCRIPTION OF THE SEVERAL VIEWS OF THE DRAWING

FIGS. 1 thru 24 are of a small section of flat sheet material, pierced with nano tubes. The nano tubes on one side extend past the material surface, surrounded by a shape which serves both as support and as statistically reduce likelihood a random cloud of particles will pass through. On the other surface of the material, the nanotubes openings are recessed, in a shape statistically increasing the chance random motion particles will pass through.

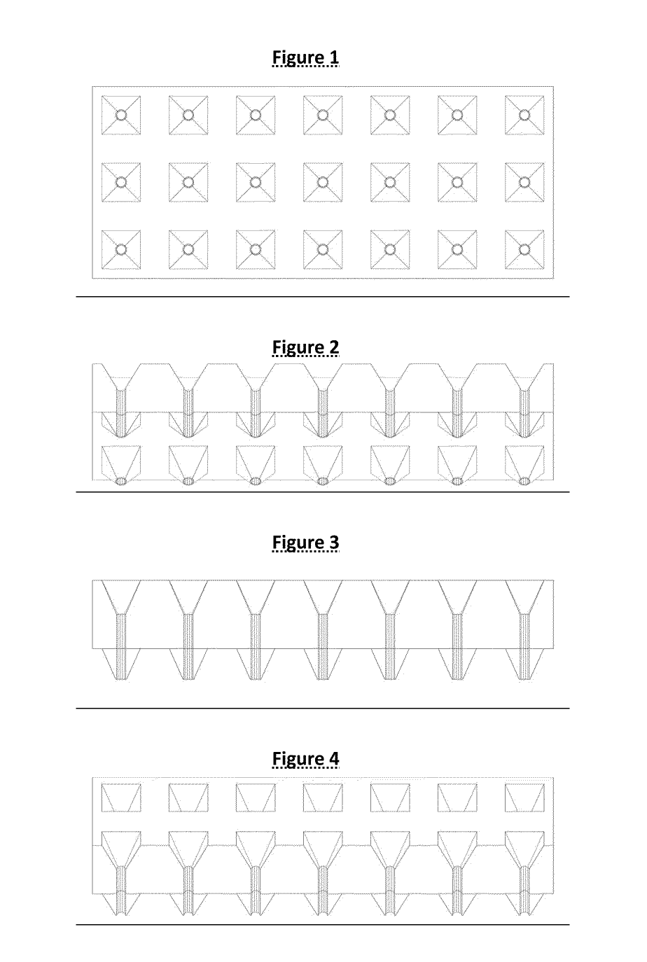

FIGS. 1, 2, 3 and 4 are bottom, orthogonal side/bottom, side cross section and orthogonal side/top, respectively. They are 2 d draftsman representation of sparsely spaced tubes, with pyramid shaped rises on one side and depressions on the other.

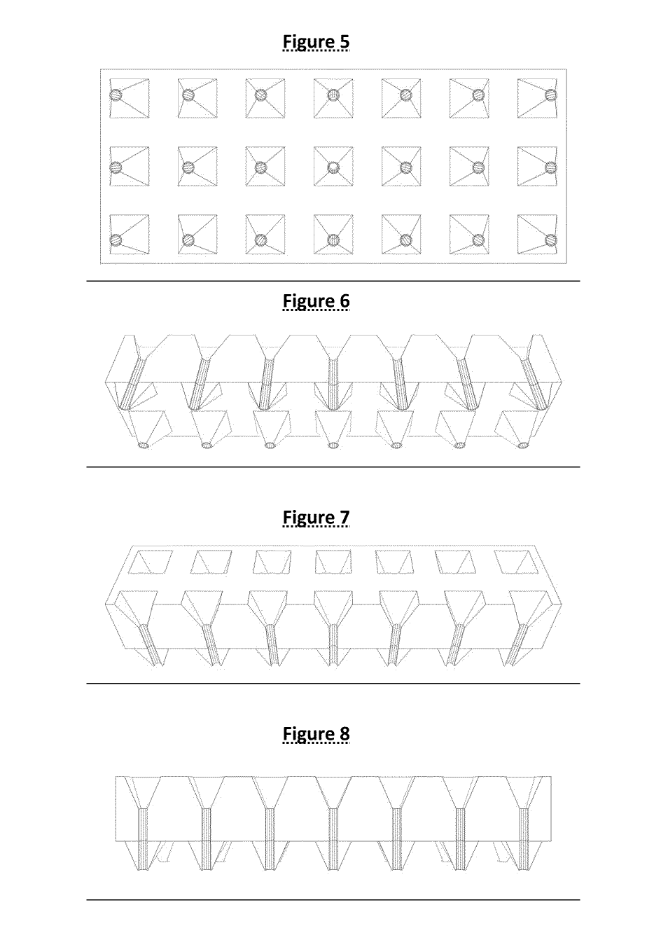

FIGS. 5, 6, 7 and 8 are bottom, orthogonal side/bottom, side cross section and orthogonal side/top, respectively. They are perspective views of the sparsely spaced tube sections from FIG. 1 thru 4, with pyramid shaped rises on one side and depressions on the other.

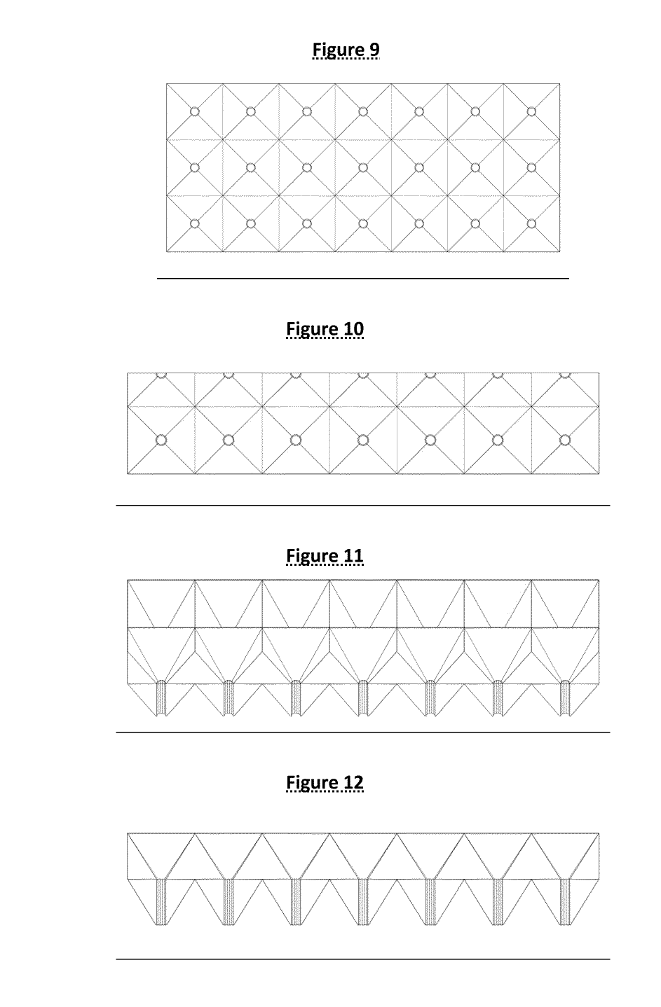

FIGS. 9, 10, 11 and 12 are bottom, bottom sliced, orthogonal top/side sliced cross section and side sliced cross section, respectively. They are 2 d draftsman representation of tightly spaced tubes, with pyramid shaped rises on one side and depressions on the other.

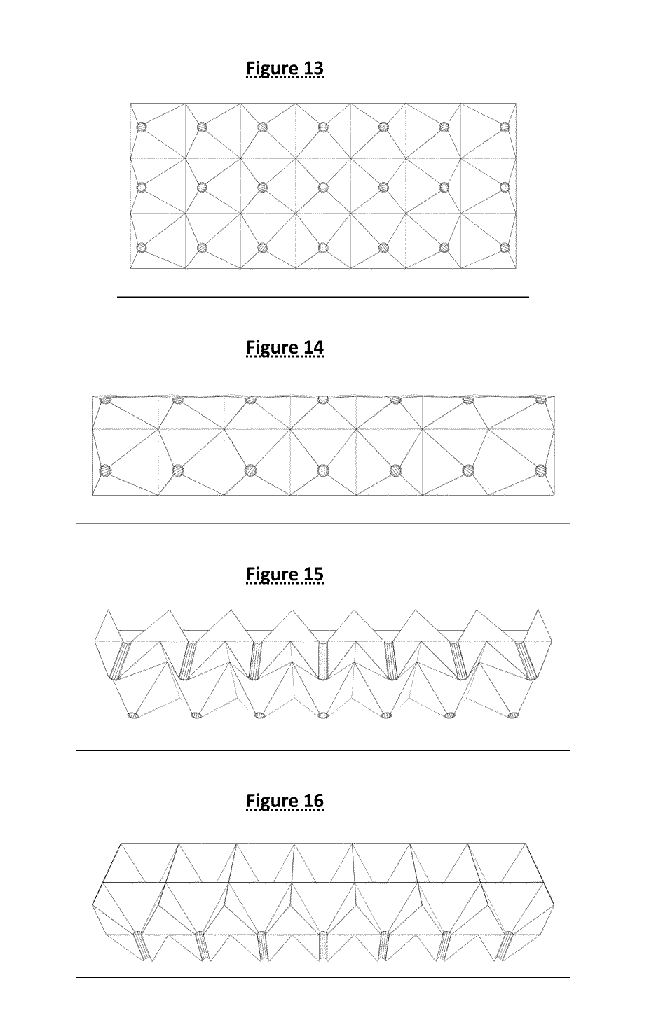

FIGS. 13, 14, 15 and 16 are bottom, bottom sliced, orthogonal bottom/side sliced cross section and orthogonal top/side sliced cross section, respectively. They are perspective views of the tightly spaced tube sections from FIG. 9 thru 12, with pyramid shaped rises on one side and depressions on the other.

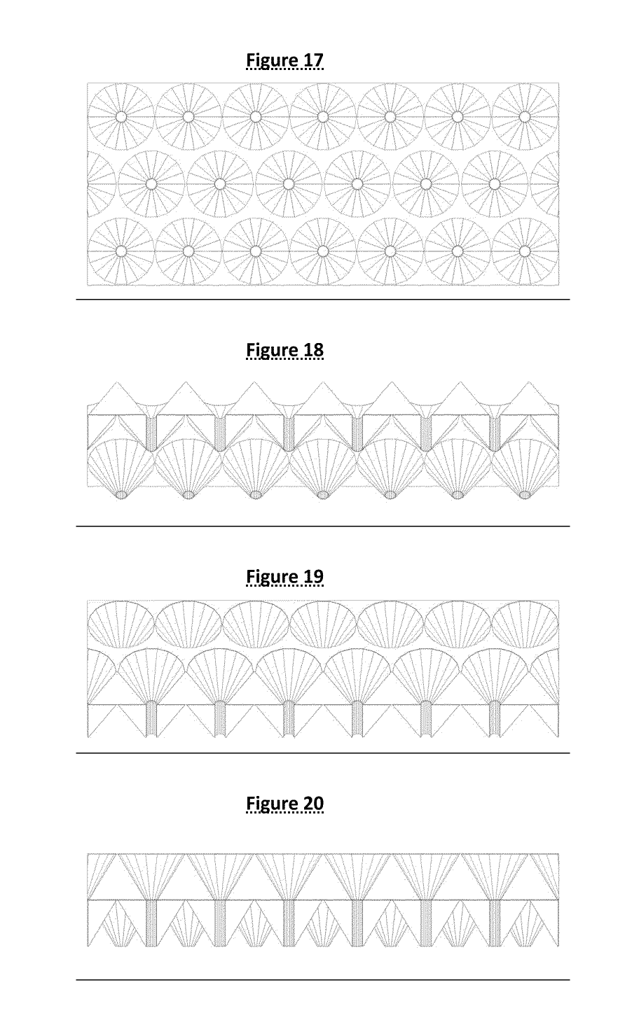

FIGS. 17, 18, 19 and 20 are bottom, orthogonal bottom/side sliced, orthogonal top/side sliced cross section and side sliced cross section, respectively. They are 2 d draftsman representation of tightly spaced tubes, with cone shaped rises on one side and depressions on the other. Additionally, the spacing between rows is staggered, for compact spacing.

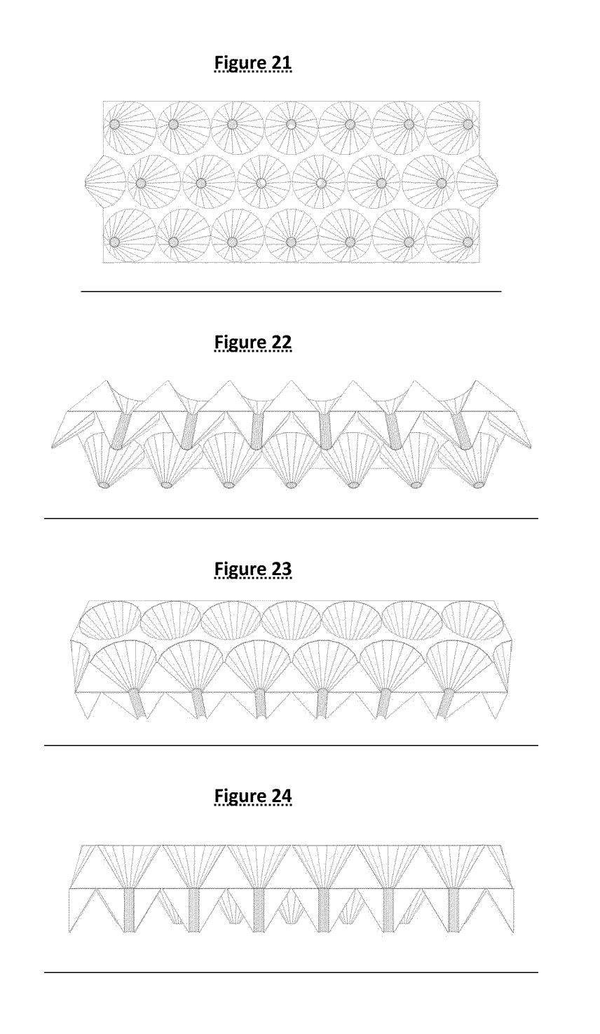

FIGS. 21, 22, 23 and 24 are bottom, orthogonal bottom/side sliced, orthogonal top/side sliced cross section and side sliced cross section, respectively. They are perspective views of the tightly spaced tube sections from FIG. 17 thru 20, with cone shaped rises on one side and depressions on the other.

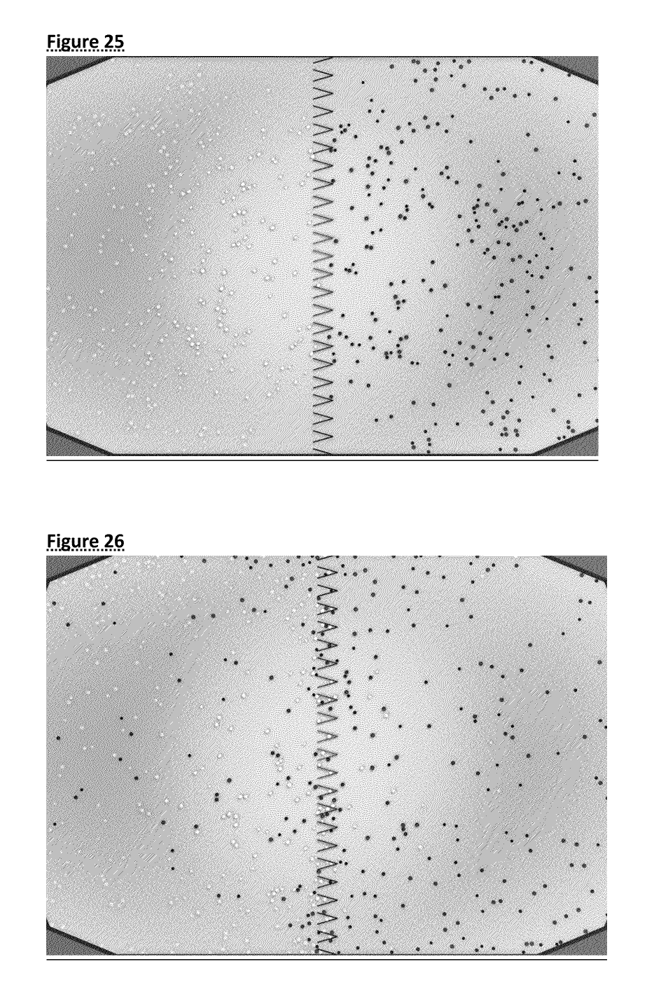

FIGS. 25, 26 and 27 are a series of snapshots of a simulation of 2 d random motion, with selective shaped divider, acute angled shapes, and small openings relative to molecule spacing. FIG. 25 shows preconditions. FIG. 26 shows early migration ratio is in the range 3 or 4 to 1 and FIG. 27 shows sustainable densities near the surface are also in the range of 3 or 4 to 1.

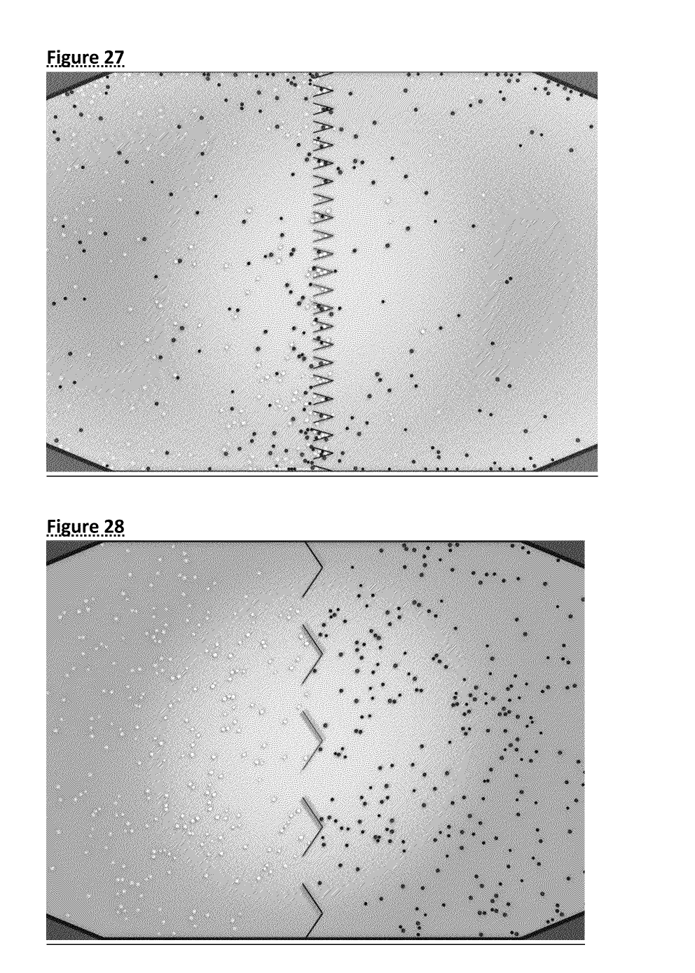

FIGS. 28, 29 and 30 are a series of snapshots of a simulation of 2 d random motion, with selective shaped divider, obtuse angled shapes, and large openings relative to molecule spacing. FIG. 28 shows preconditions. FIG. 29 shows early migration ratio is in the range 3 or 4 to 1 and FIG. 30 shows sustainable densities near the surface are also in the range of 3 or 4 to 1. (Very similar results to obtuse angles and narrower openings).

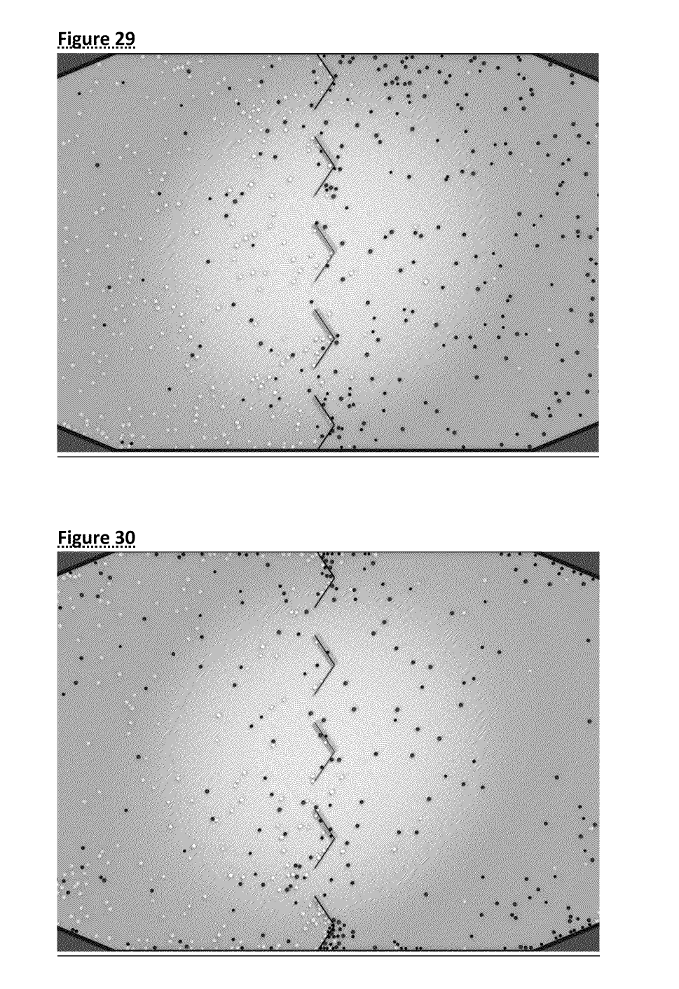

FIG. 31 shows the statistical mechanisms of selective transfer through the nanotubes.

#A Nanotubes passage

#B Solid portion of sheet

#D Region on this side increases chances of molecules entering and passing through the nanotubes in upward direction. Some collisions will deflect into tube.

#C Region in which decreases chances molecules will pass downward through nanotubes.

Some collisions from solid sheet will send molecules on trajectories which will collide with molecules on a heading to enter tube, deflecting them. No collisions with solid sheet can directly enter tube.

### DETAILED DESCRIPTION OF THE INVENTION

The device disclosed is a sheet of material or planer material with nano-tube perforations passing completely through material. The nano-surface of the low pressure sheet is shaped to increase likelihood molecules will pass into nanotubes, the nano surface of the high pressure side of the sheet is shaped to reduce the likelihood molecules will enter the nanotubes from that side of the sheet.

Depending on the relative size of molecules in the gaseous state on each side of the nano-filter-pump sheet, molecules of different sizes can have different probability of passing through. In the limiting case, molecules larger than the nanotubes openings will be unable to pass through. Smaller molecules will pass through easily. This effect can be used as a passive gas molecule sorter or filter.

The nano-shape of the surface of the filter sheet will allow some migration of small molecules in the reverse direction, but the migration will continue until equilibrium is reached, which the density of the transferable molecules on the high pressure side times the probability of random nanotubes transfer is equal to the density of the transferable molecules on the low pressure side of the sheet times the probability of transfer. For example, if the probability of random transfer from high pressure one side is 1%, and probability of transfer from the low pressure side is 20%, equilibrium is reached when the density of the high pressure side is 20 times the density of the low pressure side.

The shape can also be used to create motive force.

Even a small probability difference, 1% vs. 1.1% acting in atmosphere will create a large force, given a large area. The densities will reach equilibrium when the density on one side is 1.1 times the density on the other. At 1 atmosphere of pressure, that means 10% of 15 pounds per square inch (PSI) or 1.5 PSI net force. For this case, a 10″ by 10″, 100 square inch area of nano-filter-pump material would produce 150 pounds of force, enough to lift a small person.

FIG. 29 shows multiple ways probability of transfer can be affected.

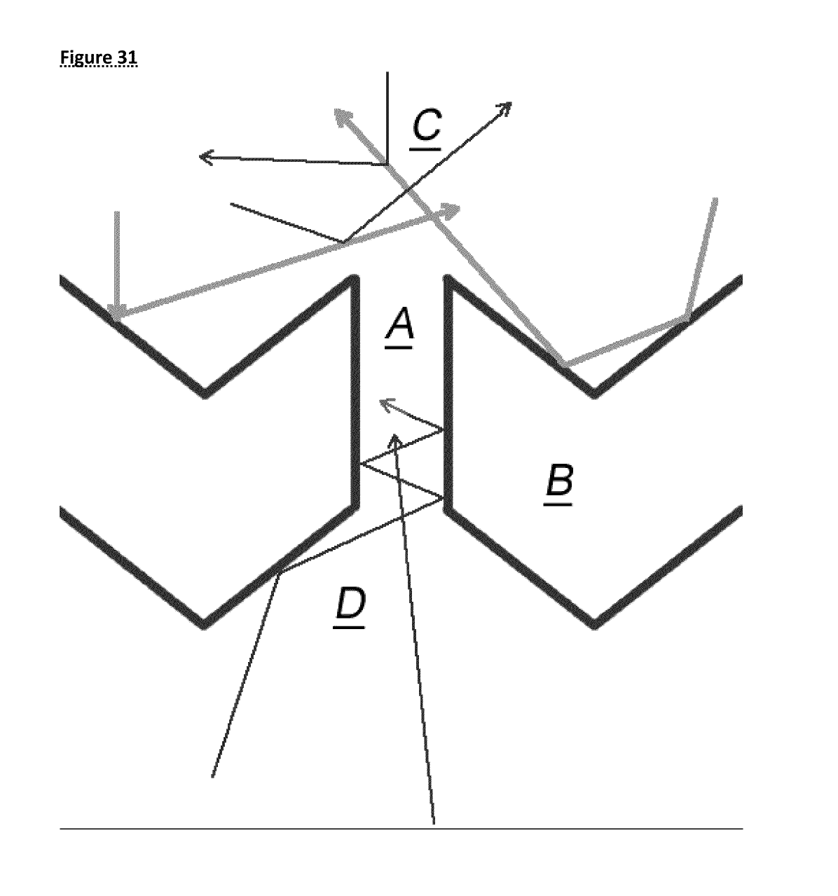

1) The size of the nanotubes openings on either side of sheet can be manipulated by making the tube into a funnel shape instead of a cylinder. So the probability of transfer is relative to the size of each opening. 2:1 funnel shape creates approximately double probability of transfer in the direction of the funnel. See FIG. 31 area A, which shows a cylindrical passage. This passage can be instead made funnel shaped.

2) The material may be modified on one side to create lower pressure by forming a funnel shaped entrance to the nanotubes (including cylindrical shaped nano-tubes). Although all molecules striking the wider funnel of the material will not pass through, some percentage of them will be able to bounce singly or multiple times directly into the nanotube's opening. If the inverse shape is on the other side of the sheet, no molecules colliding with the material on the opposite side can traverse (bounce) directly into the nanotube's opposite side. See FIG. 31 area D.
3) If the shape of the sheet on the other side can be modified to create higher pressure by a convex shape between nanotube openings. The random collisions with the shape will send some molecules over the openings and away from the material, to collide with and deny entry to molecules which would otherwise enter the openings. See FIG. 31 area C.

The method 3 in prior paragraph is the same effect an airplane wing uses, but on a larger scale. The leading edge creates an air wave front that will knock some air molecules up and away from the wing, as the wing passes under. This reduces the number of molecules hitting the upper surface of the wing, creating lift by reducing force on the wing's top.

The device is dependent on being able to create repeating structures near the size of nitrogen (N2), Oxygen (O2), Carbon dioxide (CO2) and water vapor (H2O). These molecules range from 200 pico-meters to 400 pico-meters, or 0.2 nanometers to 0.4 nano-meters.

Spacing of air molecules in atmosphere is likely to be an important design measurement as well. Nitrogen is the highest percentage component of air. Liquid nitrogen is about 600 times denser than gaseous Nitrogen (N2) at standard temperature and pressure (STP). Taking the cube root, spacing of air molecules in every direction is between 8 and 10 molecule sizes. So molecule spacing is between 1600 pico-meters or 1.6 nano-meters, and 4000 pico-meters or 4 nano-meters.

Carbon nano tubes are reported from very small, diameter 2 nano-meters, to several orders of magnitude larger. 2 nano-meters is in the ideal range for this device. If possible, a funnel shaped opening from 2 nanometers down to ½ or ¼ of a nanometer would be ideal.

However, a simple tube of constant diameter will work fine, if the opposite surfaces of the material are made to increase and decrease, respectively, the probability of molecules transferring through the nanotubes.

Strength of the material should minimally be able to handle double the atmospheric pressure, the limit of its own effect, plus significantly more if it is subject to additional forces, especially explosive forces. 30 pounds supported by 1 square inch would break most thin material sheets we are familiar with, plastic wrapping or paper for example. The material may need to be reinforced with fibers or a net of strong materials, silk, steel, nylon as examples. Rip stop nylon would be an ideal model to prevent sheeting holes from propagating to rip entire sheet and catastrophic failure. If properly engineered, repair can consist of plugging punctures.

There are an outstanding array of applications:

As direct motive force, “sails” which apply direct force in the direction pointed, would move ships, wheeled vehicles, airplanes.

Direct drive fans, similar to turbine blades, could move electric generators, power conveyors or machines.

Direct lift would make feasible airplanes, helicopters, even cars, which fly without moving wings or blades.

All applications would be virtually silent, making a wind noise at most.

Direct compression of air can be stored, or be used to power heat engines (which are powered by the heat of the air).

All these applications are possible with no external fuel, using the heat energy from the sun, stored in the air.

1. Devices disclosed are a class of static nano shapes designed to filter air, vapor or other gaseous state material, and/or pump air, vapor or gaseous material, based on selectively directing the random particles making up the air, vapor or gaseous state material.

2. Devices cited in claim 1 are generally sheets of material, or planer material, and can be combined into other shapes as needed.

3. Devices cited in claim 1 can are powered by heat energy in the atmosphere, which came from solar power, and is available 24 hours a day worldwide, even in arctic regions.

4. Devices cited in claim 1 require no fuel source other than heat in the air.

5. Devices cited in claim 1 can provide motive force for machines, vehicles, lifting surfaces, air turbines, heat engines (powered by atmospheric heat), and power generation.

6. Simulation shows feasibility of concept of devices cited in claim 1.

7. Current technologies, such as carbon nanotubes, are suitable building blocks, showing devices sited in claim 1 are manufacturable.

8. Devices sited in claim 1 can be used to filter gaseous materials based on molecular size.

9. Devices cited in claim 1 can create a pressure difference between planer sides.

10. Devices cited in claim 1 can create pressure differences capable of providing motive force in any direction without relative motion (such as airplane wings), or relative wind motion, while in the atmosphere.

11. Devices cited in claim 1 can cause air to be compressed, without additional energy being added, using only energy already in the air.

12. Devices cited in claim 11 can be used to store energy, store air or other vapors.

13. Devices cited in claim 8 can be used in chemical separation of gases, including air, humidification, dehumidification.

14. Devices cited in claim 5 can provide lift for very large masses to the rarified regions of the atmosphere.
